(19) United States
(12) Patent Application Publication
(10) Pub. No.: US 2009/0231190 A1
(43) Pub. Date: Sep. 17, 2009

(54) Electronic Tracking of Land Use Activities

(76) Inventor: Ernest W. Grumbles, Saint Paul, MN (US)

Correspondence Address: MERCHANT & GOULD PC, P.O. BOX 2903, MINNEAPOLIS, MN, 55402-0903, US

(21) Appl. No.: 12/403,136

(22) Filed: Mar. 12, 2009

Related U.S. Application Data
(60) Provisional application No. 61/035,955, filed on Mar. 12, 2008.

(51) Int. Cl. G01S 1/00

(52) U.S. Cl. 342/357.07

(57) ABSTRACT

Example systems and method described herein relate to electronic systems that allow land users to determine their location, determine the permitted activities for the specified location (based on day and hour) and communicate with land managers or other land users on permissions, conflicts or other issues. The example systems and methods will also allow land managers to track land users and communicate with them. In the examples shown, land users carry mobile devices that allow the land users to track their positions in relation to the geography of the land, as well as other land users. In addition, some examples described herein include devices that allow land owners or land managers to track land users and land use.

### RELATED APPLICATION(S)

This application is a non-provisional of U.S. Patent Application Ser. No. 61/035,955 filed on Mar. 12, 2008, the entirety of which is hereby incorporated by reference.

### BACKGROUND

Land use management, whether public or private, is a function of mapping, zoning, other regulatory and statutory restrictions and enforcement—all for the purpose of balancing the rights of landowners, the rights of land users, and ecosystem function. Given the complexity of the foregoing task, it is not surprising that a variety of land use conflicts arise between land managers and land users and between land user groups. Such conflicts are compounded by the fact that (a) allowed uses vary by parcel (adjacent parcels can have dramatically different permitted users), (b) allowed uses vary by calendar and even time of day (such as duck hunting), (c) uses vary by the quantities of persons in the specified parcel (for example, the number of hikers or hunting parties) and (d) communication in real time between land owners and users and between user groups in remote, rural or wilderness areas on permitted uses is difficult at best.

For example, hunters and other individuals that carry weapons (e.g., guns, bows/arrows, knives, etc.) for personal safety, target shooting, or hunting are subject to a complex array of regulations related to firearm usage, game regulations, and property laws. Nearly all of these restrictions are functions of geography and calendar. Violations of the restrictions can result in civil and criminal penalties, fines, and/or imprisonment.

Firearms laws vary by jurisdiction and are subject to usage limits tied to specific geographies. For example, the U.S. and Canada vary on firearms usage and handling requirements and licenses. States and even municipalities, such as counties and cities, can also have their own regulations and restrictions. Restrictions can also vary between types of federal and state lands, like national parks, national forests, federal designated wildernesses, national and state wildlife refuges, marine preserves and others. For example, guns may be permitted in national forests, but not in national parks. Some wildlife refuges permit firearms and others do not. Similar variances exist between state land types. Criminal and civil penalties can apply to improper possession of a firearm in designated areas. For example, the penalty of being in possession of a firearm in restricted locations or during restricted time periods can include fine, imprisonment, or license revocation.

Game laws also vary widely by jurisdiction and by calendar. Federal laws, which protect and regulate hunting of migratory waterfowl, and state laws, which generally protect and regulate hunting of other game species, vary by location and time of year. For example, duck hunting and deer hunting are only permitted on certain public and private lands during certain times of year or in certain times of the day. Conversely, in some jurisdictions, rabbits and squirrels may be hunted at any time and on any private land outside of urban areas.

Personal safety is critical with use of firearms and, in particular, with hunting activities. It is regrettably common during various hunting seasons for hunters or other persons in proximity to hunters to be accidentally shot, injured, or killed. This may be a function of a hunter's failure to abide by safety standards (for example, wearing an orange vest). But the problem can also be attributed to lack of knowledge that other hunters or individuals are in the area.

For example, the hunter or hiker may be on one parcel of public land for which access is freely permitted and accidentally wander onto a restricted parcel of public land (such as a military reservation or wilderness area) or private land. And some of these restrictions could vary by time of year. For example, certain National Wildlife Refuges allow hiking at certain times and prohibit hiking at other times. Certain public parcels may prohibit ATV usage altogether or prohibit it only at certain times of year. Certain private land owners may allow hikers but not hunters or may allow ingress only at certain times of year. Other lands may be primarily used for forestry or mining activities, where hunting or recreational use may be more difficult from a logistics standpoint or just undesirable.

This is also an issue for private land owners, who may be granting leases on their property to groups or individuals. For safety and lease compliance, land owners need to know when persons are on their land and be able to communicate with them on land use and other issues in real time. There could be conflict or safety issues when more than one group is on the leased land at one time (including violent conflict, which has regrettably resulted in deaths recently noted in the media).

There are also some dangers that are inherent to the land itself. For example, there could be situations where there are hazards on the land, such as old mines (as in the Black Hills) for which signage may be impossible or inadequate. Hunters or hikers may inadvertently enter these hazardous areas.

Some of the problems associated with the foregoing include one or more of the following: (a) trespassing; (b) violation of game and fish laws; (c) violation of homeland security or military restrictions; (d) intrusion into sensitive habitats, with attendant environmental damage; (e) verbal and physical conflict between land user groups (hunters/hunters; hunters/hikers; Native American/others); (f) injury or death of land users due to inadequate means to differentiate hunters or others from game animals; (g) undue reluctance of land owners or managers, whether public or private, to allow land access because of inability to control access or regulate access consistent with values or laws applicable to specific locales; and (h) reluctance to engage in hunting and fishing due to complexity and uncertainty associated with game/fish/firearms/property law/personal safety/access restrictions or regulations.

Current informational sources that are associated with addressing these problems are disjointed and inadequate. For example, most highway and topography maps are inadequate and not readily available to hunters and hikers. Federal and state maps and guidebooks may be outdated. Internet web sites are tailored for only a few of the many areas entered by hikers and hunters and are not readily available on location. Finally, signage can be overlooked and deteriorate over time and is usually limited to a simple message: “State Park Property” or “Posted: No Trespassing.” Further, current Global Positioning System devices may only depict landforms or streets.

### SUMMARY

Example systems and method described herein relate to electronic systems that allow land users to determine their location, determine the permitted activities for the specified location (based on day and hour) and communicate with land managers on permissions, conflicts or other issues. The example systems and methods will also allow land managers to track land users and communicate with them. In the examples shown, land users carry mobile devices that allow the land users to track their positions in relation to the geography of the land, as well as other land users. In addition, some examples described herein include devices that allow land owners or land managers to track land users and land use.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for tracking land use activities.

FIG. 2 shows an example land use tracking device.

FIG. 3 shows an example graphical user interface for the land use tracking device of FIG. 2.

FIG. 4 shows an example graphical user interface for registering with the system of FIG. 1.

FIG. 5 shows an example graphical user interface for reporting harvesting of game with the system of FIG. 1.

### DETAILED DESCRIPTION

Example systems and method described herein relate to electronic systems that allow land users to determine their location, determine the permitted activities for the specified location (based on day and hour) and communicate with land managers on permissions, conflicts or other issues. The example systems and methods will also allow land managers to track land users and communicate with them. In the examples shown, land users carry mobile devices that allow the land users to track their positions in relation to the geography of the land, as well as other land users. In addition, some examples described herein include devices that allow land owners or land managers to track land users and land use.

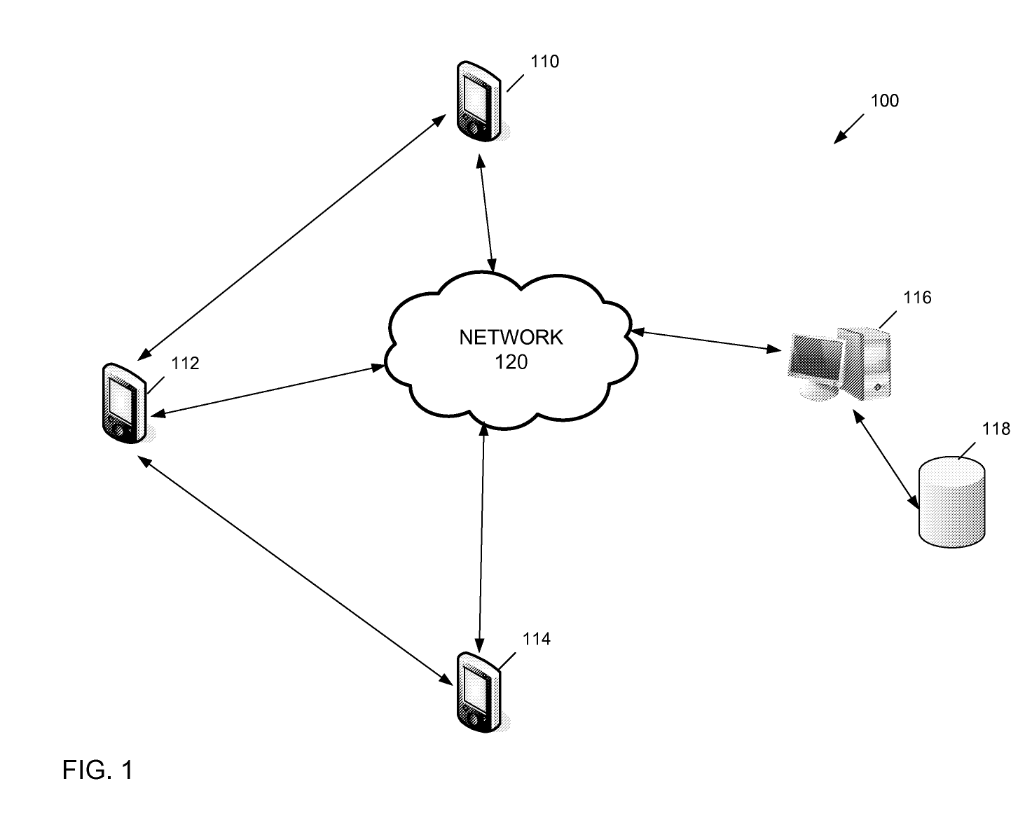

Referring now to FIG. 1, an example system 100 for tracking land use activities is shown. Generally, the system 100 includes a plurality of client devices 110, 112, 114, and one or more host devices 116. More or fewer client and host devices can be used. Communications between the devices is accomplished through a network 120, such as a LAN or the Internet.

In example embodiments, the client devices 110, 112, 114 are carried by the land users as the land users use the land. As described further below, as the land users move across the land, the land users can use client devices 110, 112, 114 to track their positions in relation to the geography of the land, as well as other land users with client devices.

The client devices 110, 112, 114 can be handheld devices that provide one-way or two-way communications with other devices and/or networks. Such devices include, without limitation, personal data assistants, Blackberrys, iPhones, mobile phones with operating systems like Windows Mobile 5.0 or 6.0, Global Positioning System (“GPS”) devices, personal locator beacons, laptops, or the like. The client devices 110, 112, 114 can be configured to communicate over one or both of wired or wireless technologies like RF, such as WiFi links, WiMax links, wireless broadband links, mobile telephone links, Bluetooth links, infrared links, etc. Other technologies can be used.

In example embodiments, the client devices 110, 112, 114 are configured to estimate the current location of each device using one or more technologies. For example, each of the client devices 110, 112, 114 can include GPS technologies to estimate the position of the client device. In alternative embodiments, other types of positioning systems, such as Assisted GPS, can be used to estimate position.

The host device 116 is typically used by a land owner or land manager to track the use of the land. For example, as described further below, land owners and land managers can use the host device 116 to track the movement of the land users carrying the client devices 110, 112, 114, as well as to track activities such as resource harvesting on the land.

In example embodiments, the host device 116 is connected to a database 118. The database 118 can be a relational database, an associative database, an object-oriented database, an online analytical processing (OLAP) database, or another type of database. As described further below, the database 118 can be used to store information related to land use, such as: land maps; location information for parties on the land; harvest information for resources taken from the land; land use restrictions and laws; etc.

In example embodiments, the client devices 110, 112, 114 and the host device 116 are computing devices including input/output devices, a central processing unit (“CPU”), a data storage device, and a network device. Typical input/output devices include keyboards, mice, displays, microphones, speakers, disk drives, CD-ROM drives, and flash drives. Computer readable storage media, such as the data storage device, provide for data retention. By way of example, computer readable media can include computer storage media and communication media. Computer storage media includes volatile and nonvolatile, removable and non-removable media implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Among the plurality of information stored on the data storage device is a client operating system (“OS”) and client applications. The client OS is a program that manages the hardware and software resources of the client system. The client applications, including the land use applications and user interfaces described herein, utilize the resources of the client devices 110, 112, 114 and the host device 116 to directly perform tasks specified by the user. The network device enables the client devices 110, 112, 114 and the host device 116 to send and receive data over the network 120. Other configurations for the devices are possible.

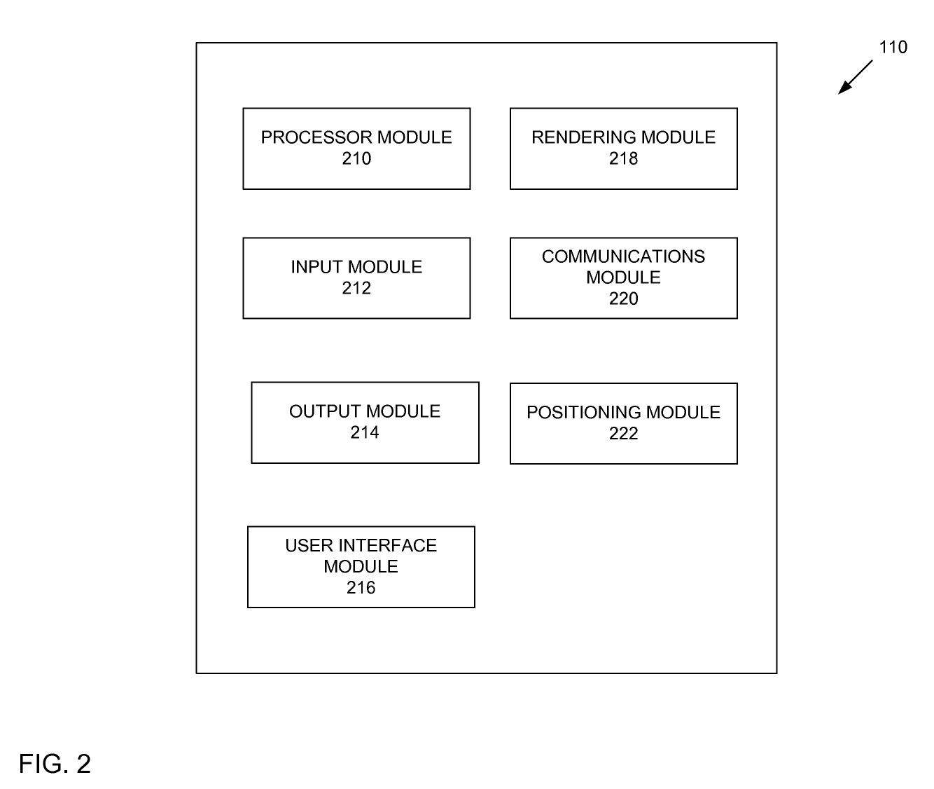

Referring now to FIG. 2, the example client device 110 is shown in more detail. The client devices 112, 114 are configured in a similar manner.

The client device 110 includes a processor module 210, an input module 212, an output module 214, a user interface module 216, a rendering module 218, a communications module 220, and a positioning module 222. Generally, the client device 110 is sized so that an individual can carry the client device 110 while the individual is using the land for different recreational purposes, such as hunting, hiking, camping, fishing, etc.

The processor module 210 is programmed to process a plurality of commands. For example, the processor module 210 is programmed to process input from the input module 212, and to provide output to the output module 214.

The input module 212 is programmed to receive input from the individual. In example embodiments, the input module 212 is a keyboard, trackball, scroll wheel, joystick, touch screen, or other physical device to receive input from the individual. In other embodiments, the input module also receives input from wireless devices like Bluetooth headsets and WiFi controllers. Other configurations are possible.

The output module 214 is programmed to provide output to the individual. In example embodiments, the output module 214 is a display that includes a graphical user interface controlled by the user interface module 216 and the rendering module 218. The output module 214 can also provide other visual, audible, and physical outputs. For example, the output module 214 can control lights on the client device 110 to provide visual feedback, can control a speaker to provide audible feedback, and can control a motor to provide physical (e.g., vibrational) feedback to the individual. For example, the output module 214 can be programmed to provide visual, audible, and physical alerts when the individual approaches another party or a hazardous condition on the land, as described below. Other configurations are possible.

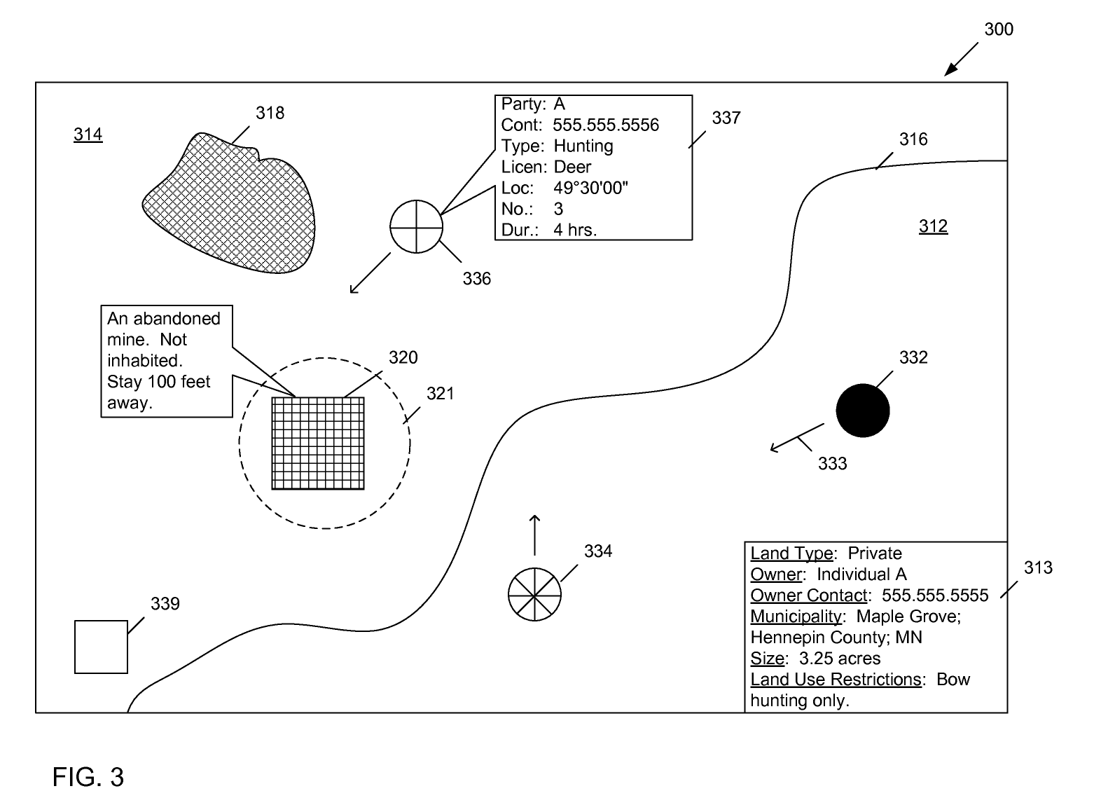

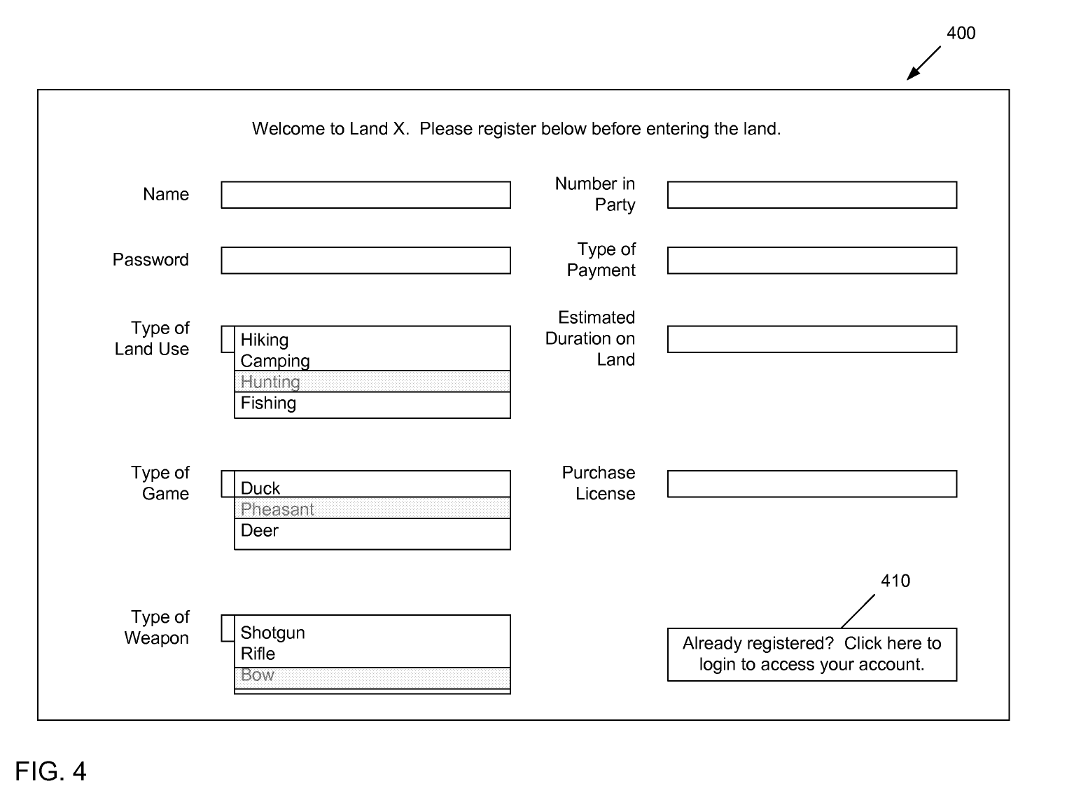

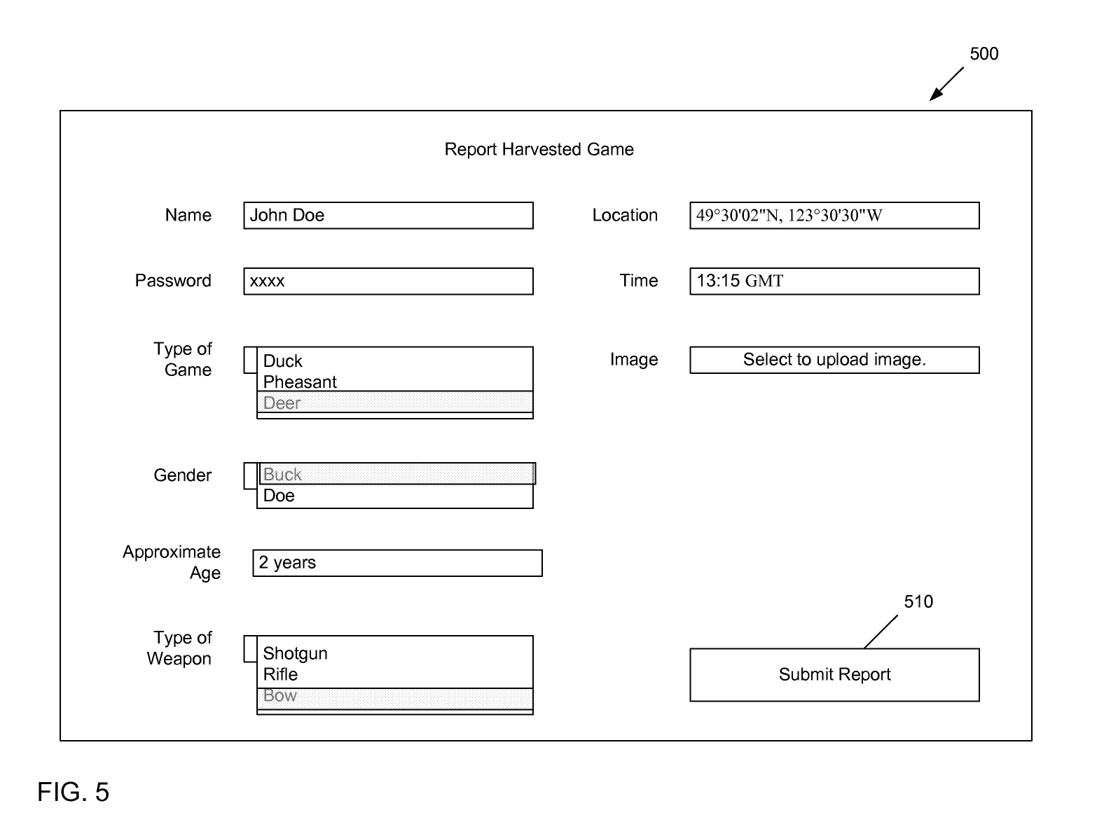

The user interface module 216 is programmed to provide visual output to the individual. The rendering module 218 is programmed to render one or more images on the user interface module 216. For example, as shown in FIG. 3 described below, the rendering module 218 is programmed to render one or more maps on the user interface module 216. The user interface module 216 can also present various interfaces to the user to collect user interface, such as the interfaces shown in FIGS. 4 and 5.

The communications module 220 is programmed to accept input from wired and wireless sources, as well as provide wired and wireless output. For example, the communications module 220 is programmed to allow voice communications over a cellular network or through other two-way radio transmissions, as well as to allow data communications over a broadband or a WiFi network. For example, in one embodiment, the communications module 220 is programmed to allow one or more of the following: (i) provide voice communications so that the individual can communicate with other parties on the land; (ii) provide data communications so that the individual can download land maps and updated information on the location of other parties on the land; and (iii) provide data communications so that the individual can report the individual's position or status or land use activities to a central server or other parties on the land. The communications module 220 can be used for other purposes as well. For example, the communications module 220 of the client device 110 can be used to summon emergency personnel in the case of an accident. Other configurations are possible.

The positioning module 222 is programmed to estimate the current location of the client device 110. For example, the positioning module 222 can use GPS or other technology to estimate the current location of the client device 110 on the land, and can report this information to the output module 214 so that the location information can be communicated to a central server, such as the host device 116, or other parties on the land.

Referring now to FIG. 3, an example user interface 300 is shown. In example embodiments, the user interface 300 is rendered by the user interface module 216 and the rendering module 218. In one example, the user interface 300 is displayed for the individual on a display of the client device 110.

The example user interface 300 displays one or more plots of land surrounding the location of the client device 110, such as plots 312, 314. In example embodiments, the individual can zoom in and out to show more or less land within the user interface 300.

Also shown are the divisions or boundary lines between the land plots. For example, land boundary line 316 is shown that divides the plots 312, 314. The land boundary line 316 can be used by the individual to determine when the individual has crossed from one of the plots 312, 314 to the other.

The user interface 300 also provides information about each of the plots 312, 314. For example, the user interface 300 includes an information box 313 that provides the user with bibliographical information about the plot 312. The information box 313 can be displayed automatically for each plot shown, can be displayed for only the plot at which the individual is located, or can be displayed manually when requested by the user by, for example hovering a pointing device like a cursor over a plot of land.

The information box 313 can display such information as the land type (e.g., public or private), owner's name and contact information, the location of the plot, the size of the plot, and any land user restrictions or permissions associated with the plot. The individual can, for example, use the land owner's contact information to contact the land owner to request permission to enter or hunt on the land owner's land. The individual can use the client device 110 to make such a request using voice or data communications. For example, the client device 110 can provide data communications such that the user can send an electronic request to the land owner with information about the individual party size, requested activity, and other information like desired activity duration. The land owner can, in turn, respond with an electronic communication either approving or denying the request. Other information, such as payment for lease, can be similarly accomplished using the client device 110. Other configurations are possible.

The user interface 300 also displays other features associated with the land, such as the location of the various parties on the land. Such location information can be coordinated by each party carrying a client device and having each client device report the current location to a central server, such as the host device 116. The host device 116 can, in turn, report each party's location as requested by each client device. In alternative embodiments, each client device can communicate with other client devices directly to report location information. In yet other embodiments, not every party needs to carry a client device. Some parties can opt to carry a device that only reports the party's current location without providing information about other parties' locations. Other configurations are possible.

In the example shown, the parties include the individual 332, as well as other parties 334, 336, 339. The different parties can be coded for ready recognition. For example, the individual 332 is coded with a solid icon, the party 334 is coded with an asterisk icon to signify a hiking party, the party 336 is coded with a cross hair icon to signify a hunting party, and the party 339 is coded with a square icon to signify a camping party. Other configurations, such as color-coding or text, can also be used.

In the example shown, other information about each party can also be provided. The individual can hover over or otherwise select another party to learn additional information about the party. For example, when the individual selects the party 336, an information box 337 is presented with bibliographical information associated with the party such as: party name (e.g., real name or other designator for a particular party for privacy considerations); contact information (e.g., telephone or electronic address); party type (e.g., hunting, fishing, hiking, camping, etc.); licensing information; current location; number of individuals in the party; and duration the party has been, or will be, on the land. Other information and configurations can be provided.

The user interface 300 also provides an indication of the current movements of each party. For example, an arrow 333 provides an indication of the current direction the individual 332 is moving over the plot 312. In other embodiments, the user interface 300 can provide a historical trail for each party so that each party's path can be determined. Such information can be useful, for example, to allow each party to track other parties' movements to avoid confrontations.

In addition to providing party location information, the user interface 300 can also provide other information, such as landmarks like structures and hazardous land conditions. For example, in the embodiment shown, the plot 314 includes landmarks 318, 320. The landmark 318 signifies a hazardous land condition, such as an abandoned underground mine. The landmark 320 signifies an abandoned mine, but could also be other land types, such as a sensitive natural habitat. In examples, the individual can select each landmark to learn more information about the landmark. For example, when the individual selects the landmark 320, an information box is provided to tell the individual that the landmark is an abandoned mine and that the individual should stay 100 feet away from the mine. In the example shown, the landmarks are coded using hatching, shading, or color to identify different types of landmarks, such as hazardous land conditions, land structures, etc.

In some examples, the safe boundaries for approach of a landmark can also be shown on the user interface 300. For example, a boundary 321 is shown around the landmark 320 to identify the boundary to which the individual can approach the landmark 320. In one example, the client device 110 is programmed to provide an alert (e.g., visual, audible, or physical) to the individual as the individual approaches the boundary 321 to warn the individual. Other configurations are possible.

In example embodiments, the land owner or land manager can also access a user interface similar to that of the user interface 300. For example, the land owner can access a user interface on the host device 116 to track use of the land. In one embodiment, the land owner can access the user interface through a web interface over the Internet. For example, the land owner can use a browser on the land owner's computer to remotely log into an account hosted on the host device 116 and to access the user interface through the browser on the land owner's computer. Other configurations are possible.

Referring now to FIG. 4, an example graphical user interface 400 is shown. The interface 400 can be presented to the user when the user wishes to register with a land manager to enter land. The interface 400 can be presented on the device 110 or another device, such as the user's desktop or laptop computing device. In examples, the interface 400 can be presented to the user in a browser or as an interface of a proprietary application.

In the example shown, the interface 400 collects a plurality of information about the user and the user's intentions on the land. This includes the user's name, a password to create an account, and information about the land use. For example, the interface 400 asks that the user define the type of land use and the type of game (if hunting or fishing) and weapon (if hunting). In addition, other information, such as the number in the party, type of payment to be used to purchase licenses, and estimated duration on the land are also collected. Other information, such as additional bibliographic information, can also be collected. The interface 400 also includes a button 410 that the user can select if the user has already created an account.

FIG. 5 shows an example graphical user interface 500 that allows the user to report the harvesting of game. In examples, the interface 500 can be presented on the device 110 so that the reporting can happen in near real time.

The interface 500 collects information like the type of game, gender, and approximate age of the game. In addition, other information, such as the weapon used, is collected. Additional information, like the time of harvest and location, can be collected. This information can automatically be populated in the interface 500 by the device 110, and the user can modify the information if needed. An image of the harvest can be uploaded. Once the report is ready, the user selects the button 510 to submit the report to the system 100. As described below, the land manager can use this information to manage the land.

The land owner or land manager can track the parties' movements across the land, as well as receive and send communications to the parties. For example, the land owner can receive a request from a party to access the land owner's land, and the land owner can respond to the request. The land owner can also accept payment from a party to access the land owner's land or harvest resources thereon.

In other examples, the land owner or manager can provide a party with other services as well. For example, a state land manager can provide near real-time licenses to a party if requested. For example, if a party requests a deer tag to harvest a deer, the land manager can, in near real time, electronically issue the tag to the party so that the party can harvest the deer. For example, a hiking party can request one or more fishing licenses so that the party can fish. In some examples, the licenses can be stored in an electronic format on the device 110.

In examples, the request and response can be manual or automated. For example, the land owner can manually approve or deny certain license requests. In other examples, the client device can be programmed to automatically request a license to enter a plot of land (or to harvest particular game on the land) as the user approaches the land (as well as automatically make payment for the license, if needed), and the host device can be programmed to automatically approve or deny the request (subject to, for example, thresholds described below). Payment can be made using various methods, such as wire transfer, credit cards, Paypal account, etc. In one example, the device 110 and/or the system 100 can retain payment information so that the user can simply request the desired license without having to provide payment information each time.

In some examples, the licensing can be tailored to the particular activity. For example, parties can request micro-licenses, such as for fishing or hunting, which only last a certain number of hours or days and/or are particular for a certain plot of land. For example, a party can request a fishing license for five hours and pay a fee that is reduced from the typical fishing license that lasts for an entire season. The land manager can then track the duration using the interface that provides durational information for each party. Other configurations are possible.

In yet other embodiments, the parties can also report harvesting information electronically to the land manager or other gaming officials in near real-time. For example, a fishing party can report the number of fish caught, the location, as well as the type and size of the fish. In another example, a party can report the number of quail harvested. This information can be used to the land manager for various purposes, such as monitoring resource usage and land conservation. The information can also be used to provide dynamic pricing for licensing. For example, as a particular species is harvested or the number of individuals on the land increases, the cost associated with a license to harvest the species can be increased or decreased.

In some examples, the device 110 can be used to report other specific information about harvested game. For example, the device 110 can be used to report such information as time harvested, location harvested (through GPS), and provide audio/video of the harvested game. For example, the device 110 can include a camera that can be used to obtain an image of the harvested game. Such an image can be used to verify gender and species. Such verification can, in some instances, be done automatically by the device 110 or the system 100 through optical pattern matching. In another example, the device 110 can record audio of a given game, such as the call of a particular bird, and can be programmed to automatically recognize the species of bird.

For example, in one embodiment, the device 110 or the system 100 is programmed to calculate the number of stamps that are used for each harvested duck by optical recognition of the type of duck harvested. For example, some species of duck can require more stamps than others when harvested. The number of stamps used can be tracked, and the user can be alerted when the stamps are depleted.

In yet other examples, the device 110 can be used to report other information to land managers, such as information about invasive species. The device 110 can be used to document (e.g., time, location, image) invasive species information that can be sent to land managers. For example, the user can use the device 110 to report on an evasive species of plant that is found on the land by imaging the plant and sending the image, along with time and location data, to the land manager. The land manager can aggregate such information and use the information when developing a land use plan.

In yet other embodiments, the client device 110 also provides the party with access to accurate land maps. For example, the client device 110 can communicate with the host device 116 to access land maps stored in the database 118. Such land maps can include political maps, federal and state public land maps, and foreign land maps. These maps can be updated and provide the individual with accurate maps of the current location. For example, the maps may be maintained by a government agency or private source and can be accessed by the client device 110. In some embodiments, the maps are provided for no charge. In other examples, the individual must pay for access to each map, or purchase a service plan that provides access to one or more maps.

Other configurations are possible. For example, in some embodiments, all of the relevant maps are pre-downloaded and stored on the client device before the individual accesses the land. In other examples, the individual can request access to maps while on the land, or the client device can be programmed to automatically request maps based on the current location of the device.

In yet other embodiments, the host device can be programmed to dynamically adjust land use parameters. For example, the host device can be programmed with adjustable threshold or ratio values that limit various land use activities, such as the number of parties allowed on a particular plot of land at one time, or the number of parties allowed for a particular land use (e.g., hunting, hiking, or camping), or the amount of resources that can be harvested at one time. The thresholds or ratios can be graduated and can be configured by the land owner or manager.

For example, in one embodiment, the host device is programmed to allow only a certain number of hunting parties onto a plot of land at one time. Once the threshold is met, the host device communicates with the client devices of any additional hunting parties that approach the plot to automatically alert the parties that they are not allowed to enter the plot.

In another example, a particular land use, such as hunting, is restricted when the number of parties that are conducting other types of land uses, such as camping or hiking, exceeds a threshold and/or ratio level. The party approaching the plot can also be alerted when the particular land use moves below the threshold so that the party can then decide whether or not to enter the plot. In another example, the costs associated with particular land uses can be increased as the number of parties conducted the land use increases. For example, the cost associated with obtaining a license to hunt on a plot of land can increase as the number of hunting parties on the land increases.

In other examples, the host device can automatically limit the amount of resources that are harvested. For example, a threshold can be set so that only a certain number of deer are harvested from a particular plot of land over a particular time period, such as a week. When the threshold for the number of deer harvested is reached, all parties having licenses to harvest deer are notified and further harvesting is not allowed until the threshold is reset at the next time period.

In yet other embodiments, the host device is programmed to assist in the management of land use by directing certain party's movements on the land. For example, the host device can be programmed to alert a hiking party to move in a certain direction to minimize confrontation with one or more hunting or hiking parties, or resource harvesting activities (e.g., timber, mining). For example, the client device can be programmed to provide additional arrows (e.g., similar to arrow 333) or other indicators based on communication with the host device to direct a party's movements in a particular direction. In another example, the host device can alert camping parties so that a particular spacing between camps is maintained so that confrontation between parties is minimized. Other configurations are possible.

In other embodiments, the system can be programmed to modify permitted land uses based on the ambient conditions. The system can utilize weather information (e.g., light, barometric pressure, altitude) to tailor land use based on the conditions. For example, if a thunderstorm moves through the area causing decreased light conditions and lightning, the system can notify users of the devices that hunting with guns for certain game is restricted or prohibited for a certain amount of time due to safety concerns. Information about the ambient conditions can be obtained from a commercial source of such information (e.g., www.weather.com), or can be sensed using the devices themselves (e.g., barometric pressure sensors, or light sensors to sense ambient light). Other configurations are possible.

Limits can be based on such ambient conditions as weather or number of people on the land, as described further herein. For example, during a drought, the system 100 can be programmed to alert device 110 that fires, such as camp fires, are not permitted in certain areas.

In other examples, the client and/or host devices can be programmed to allow land owners, managers, or users to note attributes associated with the land using the client devices. For example, a user that is accessing a land plot can use the client device to note particular features associated with the land. In one embodiment, the user can note particular land features such as hazards as the user moves across the land, and the host device is programmed to save these features and provide details of these features to other client devices. In this manner, the host and client devices can be used to survey or map land. In another embodiment, the user can make annotations related to the land, such as comments on the status of the land or activities thereon, so that the user and/or others can later review the comments. For example, the user can provide comments on the state of the land, and others can review these comments when deciding whether or not to access the land. In another example, the user can annotate a particular location so that the user can later find the location again, such as a favorite hunting or fishing location.

In addition, the client device can be programmed to provide the individual with access to land use restriction information and current laws regarding firearms usage, hunting, etc. For example, the client device can be programmed to automatically access current firearm and hunting or other land use laws based on the location of the device and provide that information to the individual. In some embodiments, the client device can be programmed to warn the individual based on the current laws and the current time of year. For example, the individual can program the device for deer hunting. The device can then access current law restrictions and warn the individual before the individual moves onto a piece of land that is designated for conservation and on which hunting is banned. Other configurations are possible.

In yet another embodiment, the client device can be programmed to allow the user to select a given location and run a query regarding the attributes of the location. For example, the user can select a location to determine attributes about the location, such as owner, what types of land uses can be conducted at a certain time period, and what types of land conditions (e.g., hazards) are located on the land. The user can then contact the owner to seek permission to enter the land, if desired.

In alternative embodiments, the devices may or may not include GPS or other location based technologies. For example, in one embodiment, each device simply emits a signal, such as a personal locator beacon. In such an embodiment, a central server may not be necessary, since the devices can communicate directly with one another. The signal from one device can be received by other devices to allow the other devices to notify that an individual is within a given distance such as, for example, 1 mile, 0.5 miles, 500 yards, etc. In another embodiment, the devices can provide both a distance and directional indication. For example, the device can be programmed to estimate a distance based on the strength of the signal, as well as a directional aspect (e.g., N, S, E, W) of the signal. Other configurations are possible.

In another example, the devices can be programmed to use other indicators, such as sound, to provide information about surrounding parties. For example, the devices can be programmed to record gun fire. The recorded gun fire can be used to estimate such information as distance from the shot (e.g., by relative loudness), direction of the shot, type of gun/shot, and estimate of how far the ammunition from the gun would travel. For example, the device can be programmed to determine, based on an analysis of recorded audio from a shot, if particular gun fire is from a rifle or a shotgun. Based on this estimate, the device can determine how far a safe distance is and alert the user if within an unsafe distance from the shot.

In another alternative, the gun or other tools used by the user can be programmed to provide information to the user as well. For example, a gun can be programmed to communicate with the device or the user directly. In one embodiment, the gun is programmed to communicate with the device 110 using Bluetooth or a similar technology. The gun can include devices such as accelerometers that allow the gun to report such information as the direction the gun is pointed, pitch, yaw, and/or other variables impacting the travel of a bullet from the gun. The device 110 can use this information, along with information about the gun itself, to estimate a travel path from the bullet and report such information to other users for safety reasons.

In some examples, the device 110 or the gun can be programmed to alert and/or stop discharge of the gun if an unsafe condition is detected. For example, if the device 110 determines, based on information from the gun, that the gun is pointed at another party that is too close based on the estimate of the travel of the bullet, the device 110 can alert the user and/or stop the gun from discharging.

In another example, the gun can include imaging technology, such as infra red, laser, or thermal imaging. For example, thermal imaging can be used to estimate a type of animal at which the gun is pointed based on thermal image imprint. The gun and/or device 110 can be programmed for a particular type of game. During hunting, the gun can be used to image the game at which the gun is pointed. If the thermal imprint of the game differs from that of the programmed game, the user can be alerted and/or the gun can be stopped from discharging. For example, if the device 110 and/or gun is programmed for hunting rabbits, and the gun detects a thermal imprint that is too large for a rabbit (e.g., that of a person), the device 110 and/or gun can alert the user.

One or more advantages are associated with the land user systems disclosed herein. For example, land owners can establish restrictions on hunting in specific locations and times (pursuant to game and wildlife management best practices). Land users can readily see on a map or table what animals may be legally taken (pursuant to game laws) and what may be taken consistent with owner restrictions (which can be narrower than that permitted by game laws). Private land owners can set private regimes to enhance or protect wildlife resources by limiting certain activities, like mountain biking or turkey hunting, to very particular locations on their property—or simply bar it from specific areas (for example, where the land owners are engaging in certain wildlife or habitat improvement projects).

In addition, land owners can integrate their lands into a private permission or registration system, allowing users and land owners to track licensed usage or even allow for a near real-time permission system—such as a system allowing some amount of usage by general public up to a cap or for a certain fee. The system can also provide for micro-regulations that allow for best land management. For example, there may be a state park with a unique habitat or ecosystem, such as a fen, that may inappropriate for any use but wildlife protection. The foregoing could be accomplished via registration of user mobile phone numbers, allowing GPS tracking and text messaging, and registration of parcels with details on use restrictions and permissions.

The system allows hunters to know when other hunters or persons are in the area and for lessors or law enforcement to know the same. This can reduce the potential that any hunter or other person in the area is accidentally shot. Hunters would know where others in their party are and would be alerted to the presence of other hunters or persons on the landscape. This will better hunter choices when discharging weapons. Further, as noted, the private land owner can better maintain and operate hunting leases and prevent conflict. The system could also be used by anglers or hikers, who deal with similar issues of access and compliance with fishing regulations across multiple jurisdictions.

The various embodiments described above are provided by way of illustration only and should not be construed to limiting. Various modifications and changes that may be made to the embodiments described above without departing from the true spirit and scope of the disclosure.

What is claimed is:

1. A device configured to track a position of individuals on a parcel of land to record land use, the device comprising:
a processor; and
a computer readable storage medium encoding instructions that, when executed by the processor, cause the device to:
render a map of the parcel of land for a user of the device, the map including information about one or more other individuals on the parcel of land, the information include a location of at least one of the other individuals;
communicate a location of the device to one or more of the other individuals; and
register with a manager of the parcel of land to obtain permission for use of the land by the user of the device.

2. The device of claim 1, wherein the device is further configured to register a use of the land with the manager, the land use including one or more of hiking, hunting, and camping.

3. The device of claim 1, wherein the device is further configured to alert the user of the device when unsafe conditions exist on the parcel of land.

4. The device of claim 1, wherein the device is further configured to render the map to indicate allowable land uses and restricted land uses on the map.

5. The device of claim 1, wherein the device is further configured to present information about the other individuals on the map, the information including party name and land use activity.

6. The device of claim 1, wherein the device is further configured to report information related to harvesting of game on the parcel of land.

7. The device of claim 6, wherein the report includes at least type of game, time, and location.

8. The device of claim 7, wherein the time and location are automatically reported based on global positioning system technology of the device.

9. A system for tracking land use on a parcel of land, the system comprising:
a plurality of mobile computing devices, each of the mobile computing devices including:
a first processor; and
a first computer readable storage medium encoding instructions that, when executed by the processor, cause the mobile computing device to:
render a map of the parcel of land for a user of the mobile computing device, the map including information about one or more other individuals on the parcel of land, the information include a location of at least one of the other individuals;
communicate a location of the mobile computing device to one or more of the other individuals; and
register with a manager of the parcel of land to obtain permission for use of the land by the user of the mobile computing device;
a central server computing device including:
a second processor; and
a second computer readable storage medium encoding instructions that, when executed by the processor, cause the server computing device to:
track a position of the mobile computing devices on the parcel of land;
provide the map of the parcel of land, the map including information about permitted land uses on the parcel of land, and the map including positional information for the mobile computing devices on the parcel of land; and
track land use on the parcel of land.

10. The system of claim 9, wherein the server computing device is further configured to register a land use by a party associated with each of the mobile computing devices, the land use including one or more of hiking, hunting, and camping.

11. The system of claim 9, wherein the server computing device is further configured to alert the user of the device when unsafe conditions exist on the parcel of land, the unsafe conditions including at least ambient conditions on the parcel of land.

12. The system of claim 9, wherein the server computing device is further configured to indicate allowable land uses and restricted land uses on the map.

13. The system of claim 9, wherein the server computing device is further configured to store harvesting information related to harvesting of game on the parcel of land, the harvesting information being reported by users of the mobile computing devices.

14. The system of claim 13, wherein the harvesting information includes at least type of game, time, and location.

15. A method for tracking hunting on a parcel of land, the method comprising:
registering a plurality of users for access to the parcel of land, each of the users having a mobile computing device;
tracking locations of each of the mobile computing devices on the parcel of land;
reporting a position of each mobile computing device to the users; and
reporting hunting restrictions on the parcel of land.

16. The method of claim 15, further comprising rendering a map including the location of each of the mobile computing devices.

17. The method of claim 16, further comprising identifying hunting restrictions on the map.

18. The method of claim 15, further comprising tracking harvest information reported by the users.

19. The method of claim 18, wherein the harvesting information includes type of game, time, location, and image of game.

20. The method of claim 19, further comprising automatically identifying a species of the game based on the image.
